(19) United States
(12) Patent Application Publication
(10) Pub. No.: US 2008/0225439 A1
(43) Pub. Date: Sep. 18, 2008

(54) MAGNETIC HEAD ACTUATOR ASSEMBLY

(75) Inventor: Yukihiro Komura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/027,638

(22) Filed: Feb. 7, 2008

(30) Foreign Application Priority Data
Mar. 14, 2007 (JP) 2007-065738

(51) Int. Cl. G11B 5/55

(52) U.S. Cl. 360/264.2

(57) ABSTRACT

According to an aspect of an embodiment, a magnetic head actuator assembly comprises a magnetic head assembly, a suspension for supporting the magnetic head assembly at one end thereof, a circuit board fixed to the suspension at one end thereof for providing a circuit connection to the magnetic head assembly, the circuit board having a plurality of terminals and an engaging portion at the other end thereof and a carriage for supporting the suspension at the other end of the suspension, the carriage having a connecting circuit board having a groove for receiving a part the circuit board where the plurality of terminals are formed, a plurality of connecting terminals, and an engaged portion, wherein the engaging portion of the circuit board is engaged to the engaged portion of the connecting circuit board so as to align the terminals with the connecting terminals, respectively.

### BACKGROUND

1. Field

The present technique relates to a technique of connecting a long tail suspension and a flexible printed circuit board.

2. Description of the Related Art

Examples of the related art pertaining to the technique of connecting a flexible printed circuit board include Japanese Unexamined Patent Application Publication Nos. 11-120715 and 2006-31764.

### SUMMARY

According to an aspect of an embodiment, a magnetic head actuator assembly comprises a magnetic head assembly, a suspension for supporting the magnetic head assembly at one end thereof, a circuit board fixed to the suspension at one end thereof for providing a circuit connection to the magnetic head assembly, the circuit board having a plurality of terminals and an engaging portion at the other end thereof and a carriage for supporting the suspension at the other end of the suspension, the carriage having a connecting circuit board having a groove for receiving a part the circuit board where the plurality of terminals are formed, a plurality of connecting terminals, and an engaged portion, wherein the engaging portion of the circuit board is engaged to the engaged portion of the connecting circuit board so as to align the terminals with the connecting terminals, respectively.

### BRIEF DESCRIPTION OF THE DRAWINGS

FIG. 1 is a plan view schematically showing the inner structure of a magnetic disk device as an example of an electronic device according to an embodiment;

FIG. 2 is a perspective view schematically showing the structure of a head stack assembly according to a first embodiment;

FIG. 3 is a partial enlarged perspective view schematically showing the structure of the head stack assembly of the first embodiment;

FIG. 4 is a perspective view schematically showing a relationship between a long tail suspension and a head slider of the first embodiment;

FIG. 5 is a perspective view schematically showing the structure of the long tail suspension of the first embodiment;

FIG. 6 is an exploded diagram of a long tail suspension (I) of the first embodiment;

FIG. 7 is an exploded diagram of a long tail suspension (II) of the first embodiment;

FIG. 8 is a perspective view of a main FPC of the first embodiment;

FIG. 9 shows a detailed engagement operation (I) of the first embodiment;

FIGS. 10A and 10B show a detailed engagement operation (II) of the first embodiment;

FIG. 11 is a perspective view schematically showing a head stack assembly according to a second embodiment;

FIG. 12 is a partial enlarged perspective view schematically showing the structure of the head stack assembly of the second embodiment;

FIG. 13 is a perspective view schematically showing a relationship between a long tail suspension and a head slider of the second embodiment;

FIG. 14 is a perspective view schematically showing the structure of the long tail suspension of the second embodiment;

FIG. 15 is an exploded diagram of a long tail suspension (I) of the second embodiment;

FIG. 16 is an exploded diagram of a long tail suspension (II) of the second embodiment;

FIG. 17 is a perspective view of a main FPC of the second embodiment;

FIGS. 18A and 18B show a detailed engagement operation (II) of the second embodiment; and

FIG. 19 shows an FPC.

### DESCRIPTION OF THE PREFERRED EMBODIMENTS

Hereinafter, embodiments will be described with reference to the accompanying drawings.

A flexible printed circuit board is applied to various kinds of electronic devices. In response to an increasing demand for compact and high-performance electronic devices, a fine wiring pattern is required of the flexible printed circuit board. The electronic devices are typified by a magnetic disk device. A flexible printed circuit board of the magnetic device is required to increase the number of wiring patterns to realize additional functions. To give an example of the additional functions, a head is equipped with a heater. A current is supplied to the heater to thermally expand the head to control a distance between the head and a magnetic storage medium.

A head stack assembly of the magnetic disk device includes a long tail suspension extending from the back of a head suspension. The long tail suspension is connected to a main flexible printed circuit board to thereby supply a write current or a sense current to a head slider. In this example, a high accuracy is required for connection between a wiring pattern on the long tail suspension and a wiring pattern on the main flexible printed circuit board.

In order to increase the number of wiring patterns on the flexible printed circuit board to realize the additional functions, a wiring pattern width needs to be decreased because a size of the flexible printed circuit board cannot be changed. However, if the wiring pattern width is decreased, it is difficult to adjust positions of wiring patterns formed on the flexible printed circuit board, resulting in a problem of increasing time necessary for positioning or decreasing a positioning accuracy.

### First Embodiment

### Hard Disk Drive:

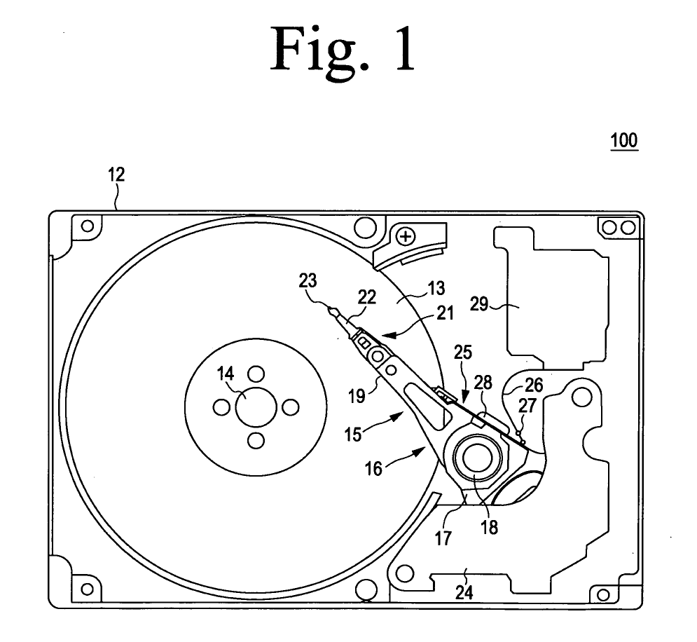

FIG. 1 is a schematic diagram of the inner structure of an HDD (hard disk drive) 100 as an example of the electronic device according to a first embodiment. The HDD 100 includes a box-shaped casing 12 designed to partition an inner space of flat rectangular parallelepiped, for example. The casing 12 is molded using a metal material such as aluminum. The inner space is sealed by bonding a cover (not shown) to the casing 12.

The inner space accommodates one or more magnetic disks 13. The magnetic disks 13 are attached to a rotating shaft of a spindle motor 14. The spindle motor 14 can rotate each magnetic disk 14 at high speeds, for example, 5400 rpm, 7200 ramp, 10000 rpm, and 15000 rpm.

The inner space further accommodates a head stack assembly. The head stack assembly 15 includes a carriage 16. The carriage 16 includes a carriage block 17. The carriage block 17 is rotatably connected to a spindle 18 extending in a vertical direction. The carriage block 17 includes plural carriage arms 19 extending from the spindle 18 in a horizontal direction. The carriage block 17 is molded using aluminum through insertion molding, for example.

A head suspension assembly 21 is attached to the tip end of each carriage arm 19. The assembly extends from each carriage arm 19 forward. A pressing force acts on the fore end of the head suspension assembly 21 toward the surface of the magnetic disk 13. A floating head slider 23 is fixed to the fore end of the head suspension assembly 21.

A so-called magnetic head, that is, an electromagnetic conversion element (not shown) is mounted onto the floating head slider 23. The electromagnetic conversion element includes a write element for writing information to the magnetic disk 13 utilizing a magnetic field generated with a thin-film coil pattern such as a thin-film magnetic head, and a read element for reading information from the magnetic disk 13 utilizing a resistance change of a spin valve film or a tunnel junction film such as a giant magneto-resistance effect element or a tunnel magneto-resistance effect element, for example. In this example, a heater (not shown) is incorporated to the floating head slider 23 adjacent to the electromagnetic conversion element. A current is supplied to the header to thermally expand the magnetic head to thereby control a floating amount of the floating head slider 23. A magnetic head assembly comprises the magnetic head and the floating head slider 23.

An ascending force and a negative pressure are applied to the floating head slider 23 by an air stream generated on the surface of the magnetic disk 13 in accordance with the rotation of the magnetic disk 13. If the floating force, the negative pressure, and the pressing force acting on the head suspension assembly 21 are balanced well, the floating head slider 23 can keep floating with predetermined rigidity during the rotation of the magnetic disk 13.

The carriage block 17 is coupled with a voice coil motor 24. The voice coil motor 24 helps the carriage block 17 to rotate about the spindle 18. Each carriage arm 19 and the head suspension assembly 21 can oscillate in accordance with the rotation of the carriage block 17. If each carriage arm 19 oscillates about the spindle 18 when the floating head slider 23 is floating, the floating head slider 23 can cross across the magnetic disk 13 along the radius direction. Along with the movement of the floating head slider 23, the position of the magnetic head is adjusted to a target recording track.

The head stack assembly 15 includes an FPC (flexible printed circuit) board unit 25 provided onto the carriage block 17 at the proximal end of the carriage 16. The FPC unit 25 includes a main flexible printed circuit board 26. The main FPC 26 may be bonded to the surface of a metal plate such as a stainless steel plate by means of an adhesive, for example. The metal plate is fixedly screwed to the carriage block 17. The metal plate may be fixed thereto through bonding and solder bonding between a pin on an actuator side and a terminal of the main flexible printed circuit board 26 as well as screwing.

A head IC (integrated circuit), that is, preamplifier IC 28 is mounted onto the main FPC 26. At the time of reading magnetic information, a sense current is supplied from the preamplifier IC 28 to a read element. Further, at the time of writing magnetic information, a write current is supplied from the preamplifier IC 28 to a write element. Likewise, a heater control current is supplied from the preamplifier IC 28 to a heater. The preamplifier IC 28 is supplied with the sense current, the write current, or the heater control current through a small circuit board 29 placed in the inner space of the casing 12. A long tail suspension 32 is used to supply the above sense current, write current, and heater control current.

### Head Stack Assembly:

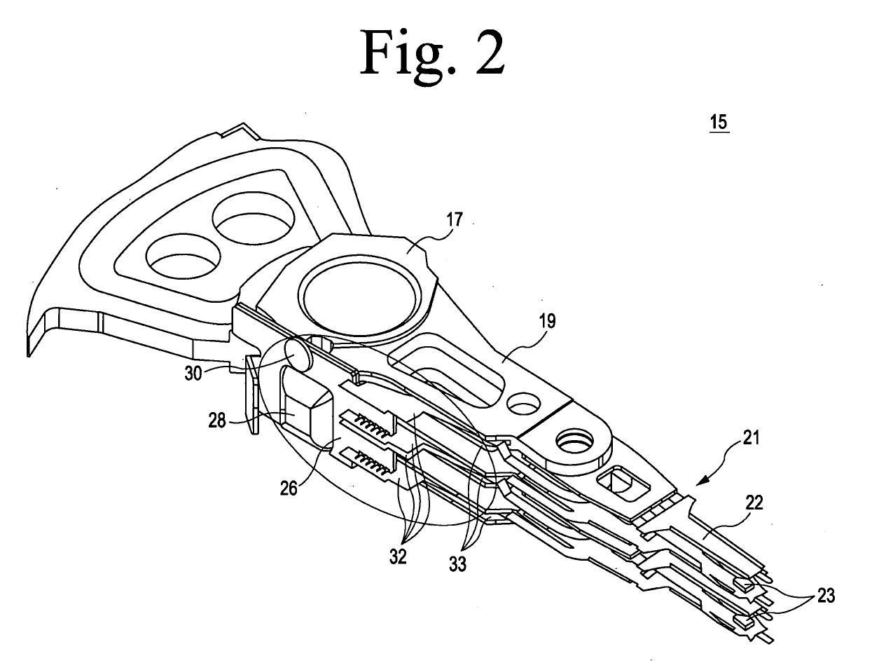

FIG. 2 is an enlarged view of the head stack assembly 15 illustrated in FIG. 1. The long tail suspension 32 has one end fixed to the head suspension assembly 21. A wiring pattern on the long tail suspension 32 is connected to the floating head slider 23. The long tail suspension 32 may be bonded to the head suspension assembly 21 by means of an adhesive, for example. On the other hand, a tail portion of the long tail suspension 32 is positioned outside the head suspension assembly 21. The tail portion of the long tail suspension 32 extends backward along the side of each carriage arm 19 from the head suspension assembly 21. Each carriage arm 19 has a groove 33 for receiving the long tail suspension 32 in a direction almost parallel to the arm surface.

The tail portion of the long tail suspension 32 is connected to the main FPC 26 on the carriage block 17. The tail portion of the long tail suspension 32 includes a tip portion. Each tip portion widens along a virtual plane parallel to the bottom of the casing 12. In this way, the tip portion is positioned vertically to the main FPC 26. In this example, four long tail suspensions 32 are arranged in a vertical direction that is orthogonal to the bottom of the casing 12, for example.

### Head Stack Assembly Enlarged View I:

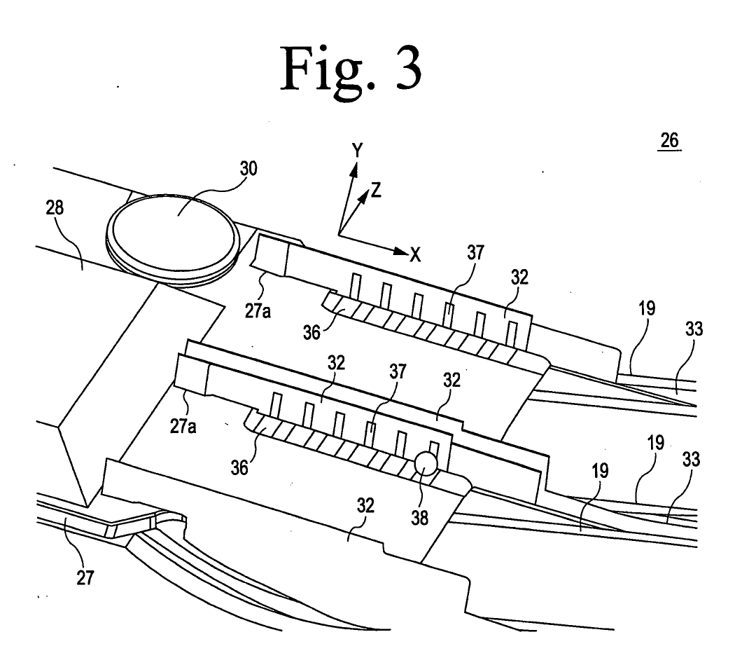

FIG. 3 is an enlarged view of an encircled portion of FIG. 2. As shown in FIG. 3, six first terminals 36 are exposed on the surface of the main FPC 26 (e.g. a connecting circuit board) for example. Each first terminal 36 (e.g. a connecting terminal) is made of a conductive material such as Cu. The first terminals 36 are connected to a wiring pattern (not shown) on the main FPC 26. The wiring pattern is connected to the preamplifier IC 28. On the other hand, six second terminals 37 are exposed on the surface of the long tail suspension 32, for example. Each second terminal 37 is made of a conductive material such as Cu. The second terminals 37 are connected to a wiring pattern (not shown) on the long tail suspension 32. Each second terminal 37 is connected to a corresponding one of the first terminals 36. The first and second terminals are bonded using a solder 38, for example. In this way, the first and second terminals are electrically connected, and the floating head slider 23 and the circuit board 29 are electrically connected.

In this embodiment, six terminals are prepared. However, this embodiment is particularly effective for wiring connection in a small region including six or more terminals. Conceivable examples of the structure using six or more terminals include such a structure that a contact detection sensor or a vibration detection sensor for a disk is mounted onto a head slider in addition to a heater.

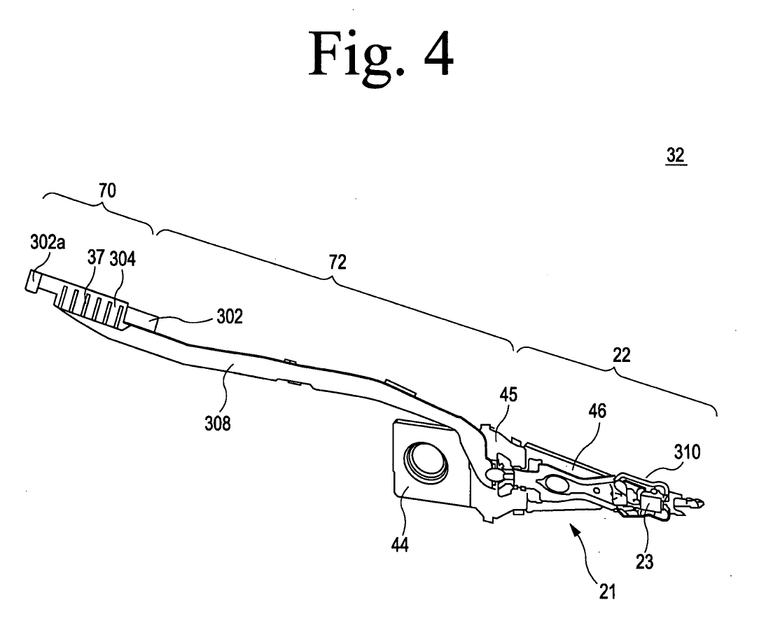

FIG. 4 shows the long tail suspension 32. The long tail suspension 32 includes a terminal portion 70, a tail portion 72, and a suspension 22. The suspension 22 supports the magnetic head assembly at one end thereof. A circuit board comprises the terminal portion 70 and the tail portion 72. The circuit board is fixed to the suspension 22 at one end thereof for providing a circuit connection to the magnetic head assembly. The circuit board has an engaging portion at the other end thereof. The suspension 22 is supported by the carriage 16. The carriage has a connecting circuit board. The head suspension assembly 21 includes a base plate 44 attached to the tip end of each carriage arm 19, an elastic deformable portion 45 connected to the base plate 44, and a load beam 46 connected to the elastic deformable portion 45. The floating head slider 23 is attached to the tip end of the load beam 46. The load beam 46 generates a predetermined load balanced with the floating force of the floating head slider 23. A bending stress is applied to the elastic deformable portion 45. Owing to the bending stress, a pressing force is applied to the fore end of the load beam 46 to press the beam against the surface of the magnetic disk 13. The floating head slider 23 is connected to a conductive layer 310 for supplying a write current, a sense current, or a heater control current.

### Long Tail Suspension I:

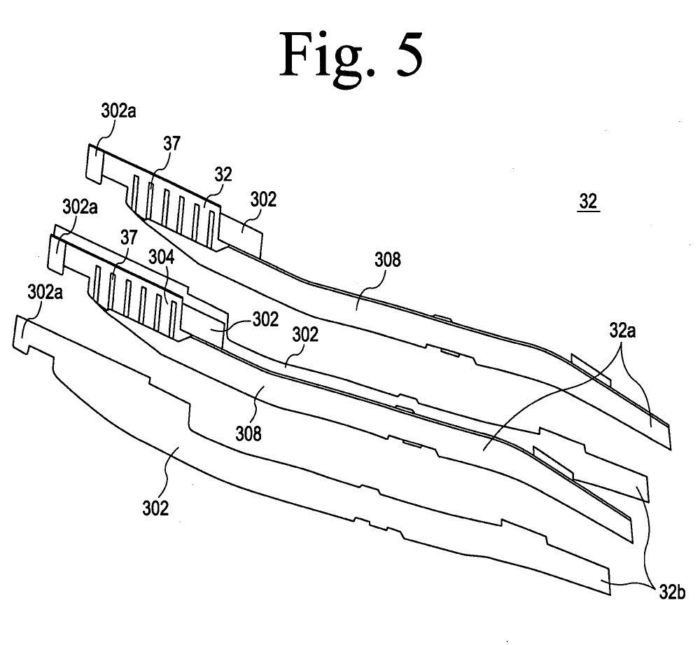

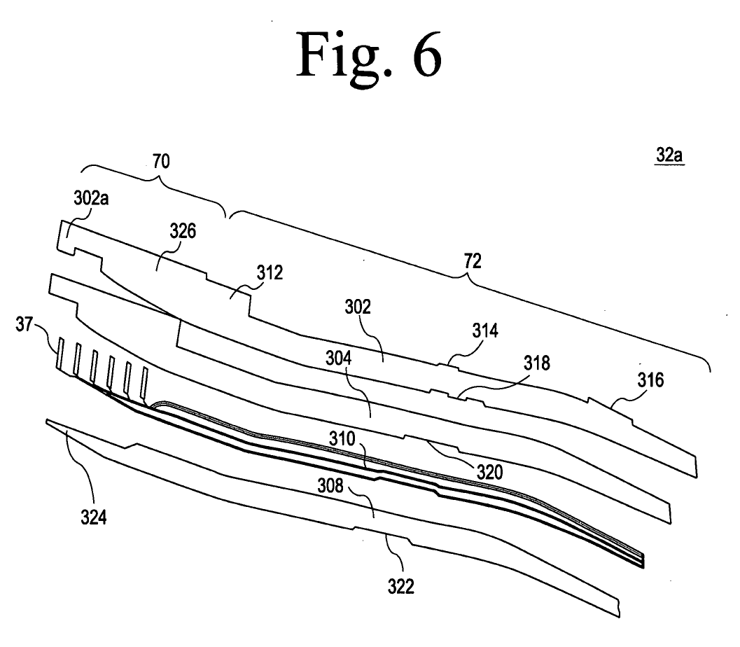

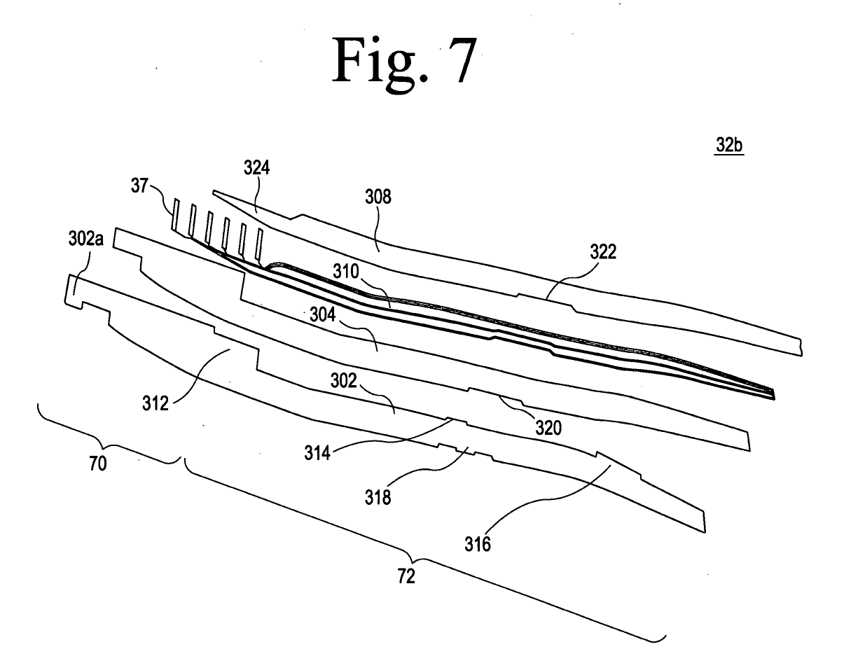

FIG. 5 shows the long tail suspension 32 of FIG. 3. FIG. 6 is an exploded diagram of a long tail suspension 32a of FIG. 5. FIG. 7 is an exploded diagram of a long tail suspension 32b of FIG. 5. In FIGS. 5 to 7, the terminal portion 70 and the tail portion 72 of FIG. 4 are illustrated and the floating head slider 23 and the like are omitted.

As shown in FIG. 6, the long tail suspension 32a includes a metal thin plate 302 such as a stainless steel plate, an insulating layer 304 made of polyimide, the conductive layer 310 made of a conductive material such as Cu, and a protective layer 308 made of polyimide. The insulating layer 304, the conductive layer 310, and the protective layer 308 are stacked in this order. These layers extend toward a left-handed side surface 326 of the metal thin plate 302. The layers are bonded using an adhesive, for example.

The metal thin plate 302 includes a projection 302a (e.g. a tab) for positional alignment to the main FPC 26, at the end opposite to the tail portion 72 of the terminal portion 70. The projection 302a protrudes toward the main FPC 26 from the long tail suspension 32 upon bonding the plate to the main FPC 26. The projection is an engaging portion or an engaged portion. If the projection 302a is inserted to a hole 27a (e.g. a slit) of the main FPC 26, the long tail suspension 32 is pulled toward the tail portion 72 to engage the projection with the hole 27a. The main FPC 26 applies a force to the side of the projection 302a in contact with the hole 27a in a direction opposite to the tail portion 72. In this way, the long tail suspension 32 is pulled toward the tail portion 72 to thereby adjust positions of the first terminals 36 and the second terminals 37. A step 312 is defined at the end of the terminal portion 70 opposite to the projection 302a. The step 312 is gripped when the long tail suspension 32 is bonded to the main FPC 26. The step 312 is formed to prevent electrostatic discharge damage of a magnetic head, which would occur in the case of directly touching the terminal portion 70. A first projection 314 and a second projection 316 are formed between the step 312 and the floating head slider 23 and between the first projection 314 and the floating head slider 23, respectively. The first projection 314 and the second projection 316 protrude toward a direction opposite to the direction from the long tail suspension 32 to the main FPC 26. Further, a third projection 318 is formed on the side of the tail portion 72 opposite to the side where the first projection 314 and the second projection 316 are formed.

A recess 320 is formed in the insulating layer 304. The recess 320 is concaved in a direction opposite to the direction from the long tall suspension 32 to the main FPC 26.

The conductive layer 310 extends along a direction from the terminal portion 70 to the tail portion 72 and is connected to the floating head slider 23. The second terminals 37 are formed in the terminal portion 70 of the conductive layer 310. The second terminals 37 extend toward a direction opposite to the projection 302a. The second terminals 37 are arranged at such intervals as to bring the second terminals 37 into contact with the first terminals 36 at the time of bonding the long tail suspension 32 to the main FPC 26.

A recess 322 is defined in the tail portion 72 of the conductive layer 308. The recess 322 is formed in a position where the recesses 320 and 322 could overlap each other if the protective layer 208 is laminated onto the insulating layer 304 and the conductive layer 310. The protective layer 308 has a width enough to cover the wiring pattern of the conductive layer 310. An end portion 324 of the protective layer 308 opposite to the tail portion 72 of the terminal portion 70 is designed so as to expose the second terminals 37 of the conductive layer 310 when the protective layer 308 and the conductive layer 310 are laminated onto the insulating layer 304.

As shown in FIG. 7, the long tail suspension 32b includes the metal thin plate 302 such as a stainless steel plate, the insulating layer 304, the conductive layer 310, and the protective layer 308. The insulating layer 304, the conductive layer 310, and the protective layer 308 are stacked in this order. These layers extend toward a direction opposite to the left-handed side surface 326 of the metal thin plate 302. The other structure is the same as that of FIG. 6, so a description thereof is omitted here.

### Main FPC I:

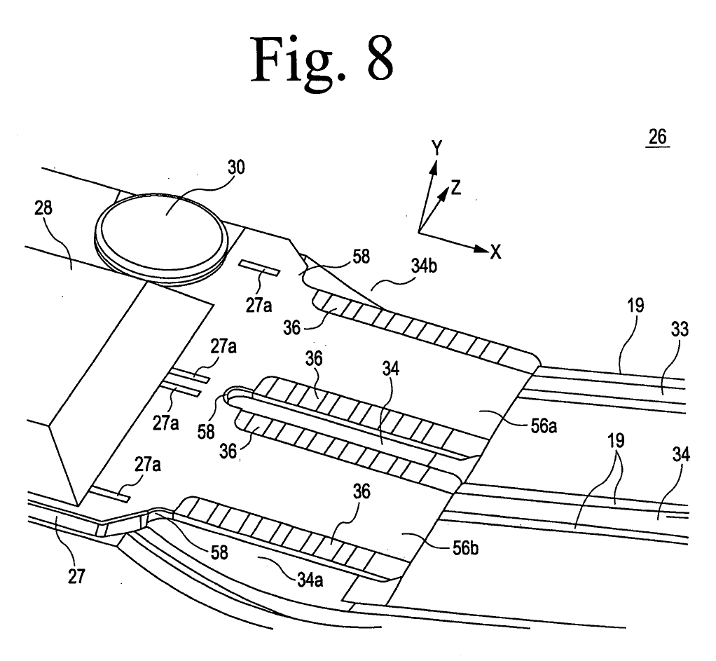

FIG. 8 shows the main FPC 26 of FIG. 8. As shown in FIG. 8, the main FPC 26 includes a first fiat portion 56a and a second flat, portion 56b. For example, the six first terminals 36 are formed at both end portions of the first fiat portion 56a and the second flat portion 56b, which are parallel to a direction In which each carriage arm 19 extends. At least two of the long tail suspensions 32 are inserted to the groove 34 defined by the first flat portion 56a and the second flat portion 56b. The groove 34 is for receiving a part the circuit board. The groove 34 includes an opening, a slit or a gap. And the main FPC 26 has an opening 34a and an opening 34b. For that purpose, the groove 34 has a width enough to receive at least two long tail suspensions 32. Further, the widths of the first flat portion 56a and the second flat portion 56b are determined in accordance with the width of each carriage arm 19.

The main FPC 26 includes, for example, four holes 27a engageable with the positioning projection 302a. The hole is an engaging portion or an engaged portion. Each hole 27a is formed between the preamplifier IC 28 and each first terminal 36 so as to align the centers of each first terminal 36 and each second terminal 37 with each other when the projection 302a of the long fail suspension 32 is inserted to the hole 27a. When the positioning projection 302a is engaged with the hole 27a, a surface portion including the first terminals 36 and a surface portion including the second terminals 37 come into contact with each other in substantially vertical direction. The first terminal 36 is wider than the second terminal 37. As a result, the first terminal 36 and the second terminal 37 can easily contact each other. The first terminals are aligned with the second terminals, respectively. The first terminals 36 are arranged at smaller intervals than the second terminals 37. In addition, the edge of the surface portion including the first terminals 36 may contact the surface portion including the second terminals 37. Alternatively, the edge of the surface portion including the second terminals 37 may contact the surface portion including the first terminals 36.

### Detailed Engagement Operation I:

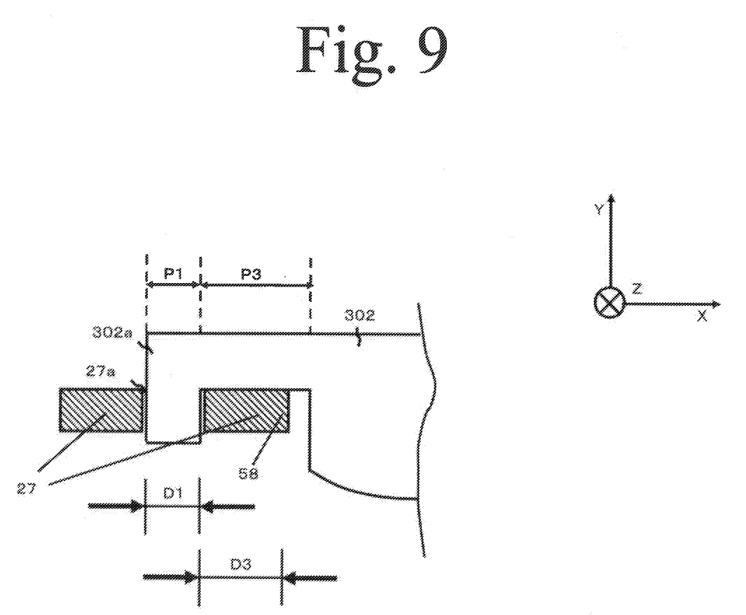

FIG. 9 shows a relationship between the positioning projection 302a and the hole 27a. A length P1 of the positioning projection 302a in an X direction, that is, a direction parallel to each carriage arm 19 is shorter than a length D1 of the hole 27a in the X direction. As a result, the positioning projection 302a can be easily inserted to the hole 27a. In FIG. 9, a length P3 is longer than a length D3. As a result, a space is left between the main FPC 26 and the long tail suspension 32. A length D3 is defined by the end portion of the hole 27a and a corner 58 of FIG. 8.

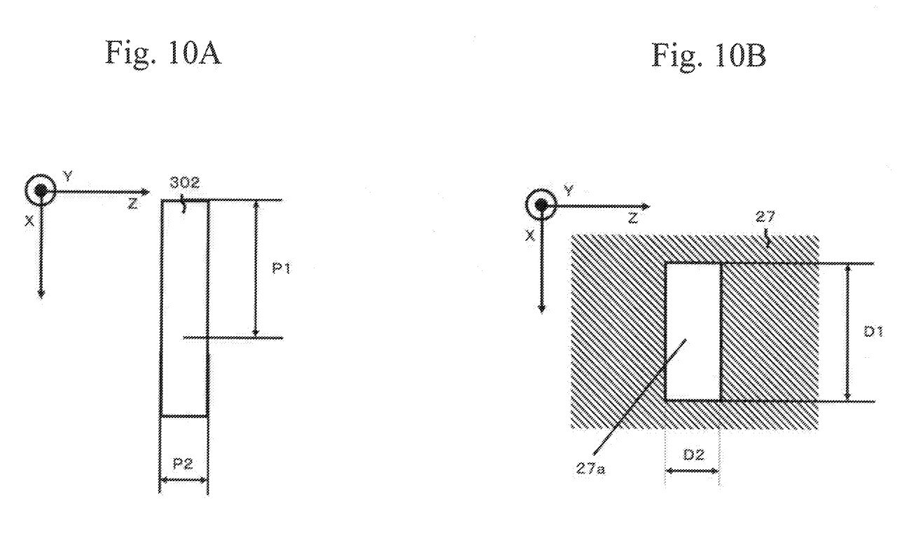

FIGS. 10A and 10B show a relationship between the positioning projection 302a and the hole 27a. A length P2 of the positioning projection 302a in a Z direction, that is, a direction vertical to each carriage arm 19 of FIG. 10A is shorter than a length D2 of the hole 27a in the Z direction as shown in FIG. 10B.

As described above, conventional main flexible printed circuit board and long tail suspension each include two terminals for supplying a sense current and two terminals for supplying a write current, that is, four terminals in total. On the other hand, in order to supply a current to a heater, it is necessary to add two terminals to the main flexible printed circuit board 26 and the long tail suspension 32. Regardless of whether or not the sizes of the main flexible printed circuit board 26 and the long tail suspension 32 are changed, the position of the long tail suspension 32 should be adjusted with respect to the main flexible printed circuit board 26 with higher positioning accuracy than before when being bonded to the main flexible printed circuit board 26. Therefore, the positioning method of this embodiment is particularly effective to bonding of terminals on the carriage 16.

### Second Embodiment

The first embodiment describes an example where the positioning projection is formed in the long tail suspension 32 and a hole engageable with the projection is formed in the main FPC 26. However, the other structure can be employed. A second embodiment is directed to an example where a positioning projection is formed in the main FPC 26 and a hole engageable with the projection is formed in the long tail suspension 32.

### Carriage Assembly II:

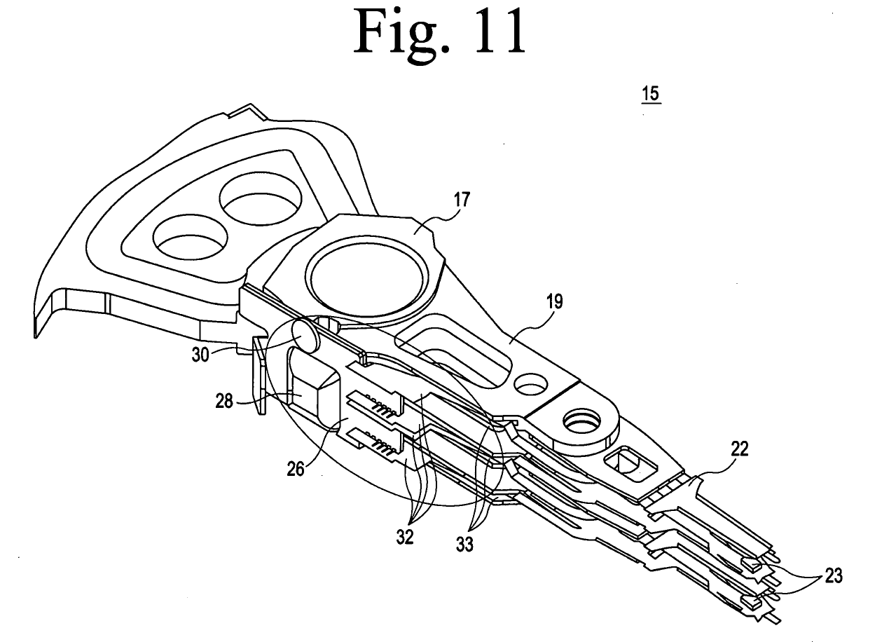

FIG. 11 Is an enlarged view of the head stack assembly 15 illustrated in FIG. 1. Its structure is the same as that of FIG. 2 except the number of terminals provided to the main FPC 26 and the long tail suspension 32, so a description thereof is omitted here.

### Head Stack Assembly Enlarged View II

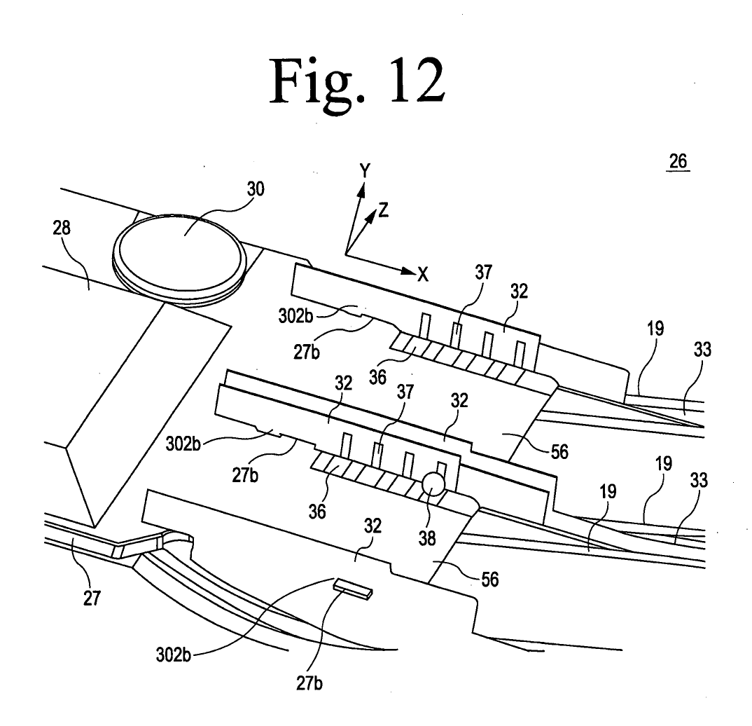

FIG. 12 is an enlarged view of an encircled portion of FIG. 11. The main FPC 26 includes a positioning projection 27b (e.g. a tab). The main FPC 26 and the long tail suspension 32 each include four terminals. The other structure is the same as that of FIG. 3, so its description is omitted here.

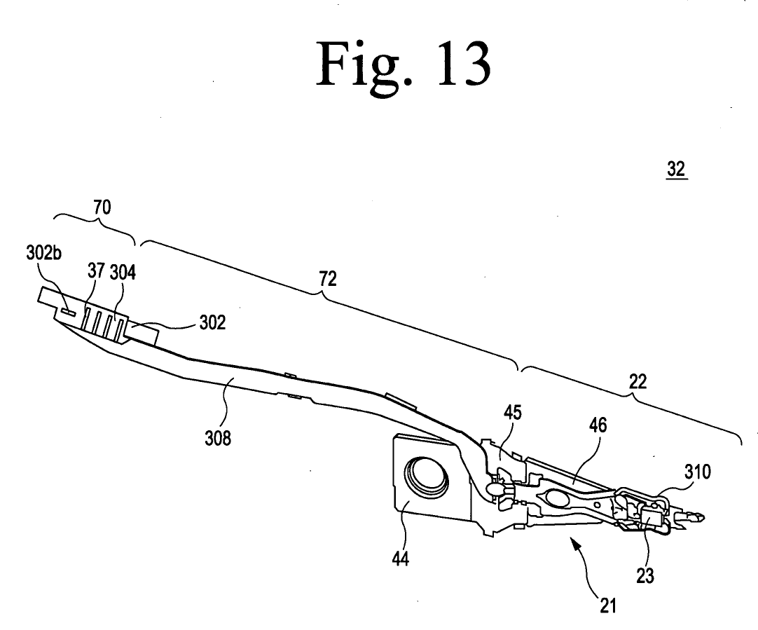

FIG. 13 shows the long tail suspension 32. The long tail suspension 32 includes the terminal portion 70, the tail portion 72, and the suspension 22. Its structure is the same as that of FIG. 4 except the number of terminals and a shape of the metal thin plate 302, so a description thereof is omitted here. The shape of the metal thin plate 302 is described below.

### Long Tail Suspension II:

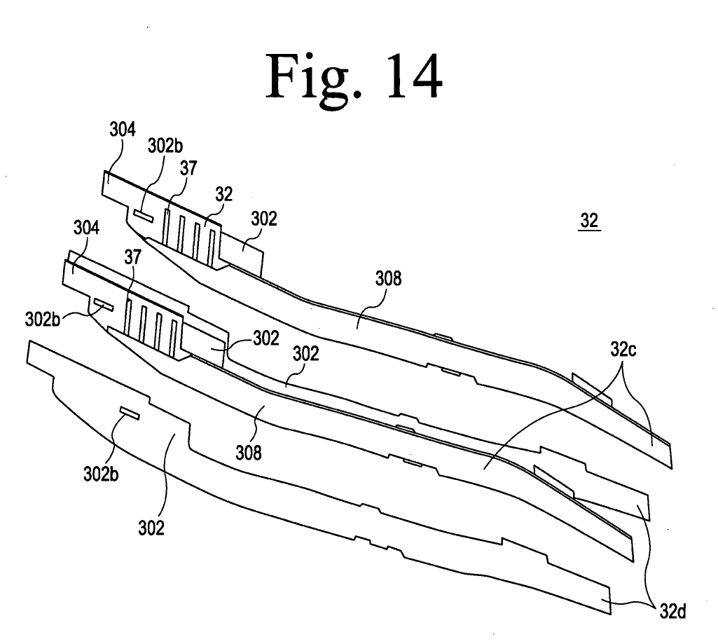

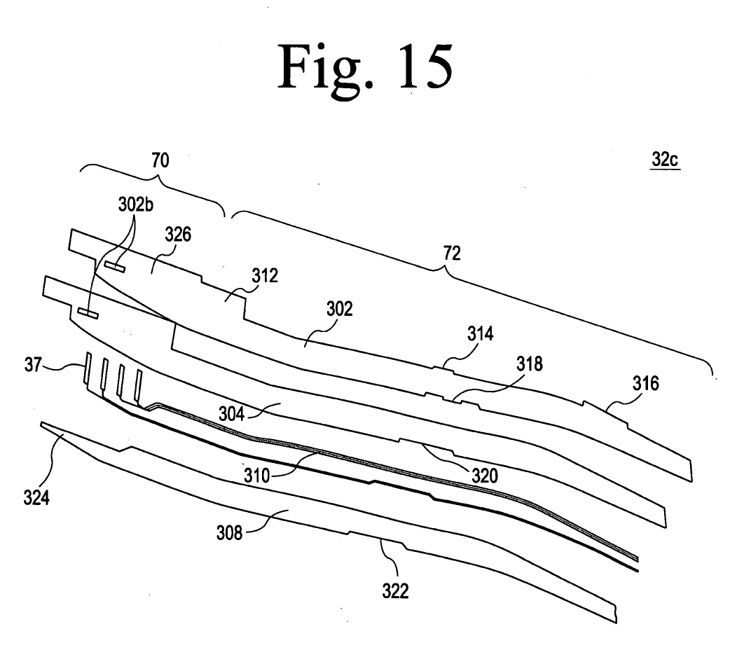

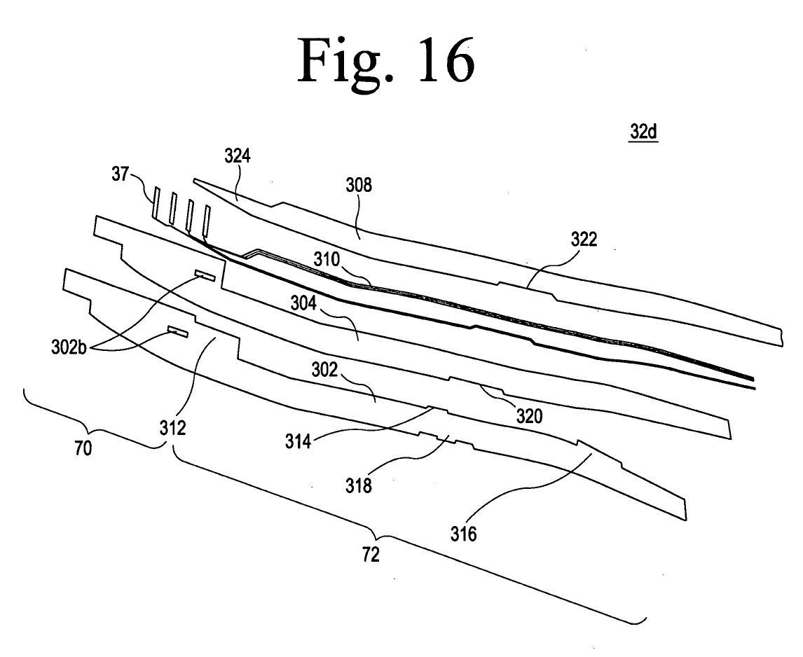

FIG. 14 shows the long tail suspension 32 of FIG. 12. FIG. 15 is an exploded diagram of a long tail suspension 32c of FIG. 14. FIG. 16 is an exploded diagram of a long tail suspension 32d of FIG. 14. In FIGS. 14 to 16, the terminal portion 70 and the tail portion 72 of FIG. 13 are illustrated.

As shown in FIG. 15, the long tail suspension 32c includes the metal thin plate 302 such as a stainless steel plate, the insulating layer 304, the conductive layer 310, and the protective layer 308. The insulating layer 304, the conductive layer 310, and the protective layer 308 are stacked in this order. These layers extend toward the left-handed side surface 326 of the metal thin plate 302. In the terminal portion 70 of the metal thin plate 302, a hole 302b (e.g. a slit) engageable with the projection 27b formed in the main FPC 26 is formed. The hole is an engaging portion or an engaged portion. The hole 302b is also formed in the terminal portion 70 of the insulating layer 304. The insulating layer 304 is laminated on the metal thin plate 302 to thereby align the holes 302b of these layers with each other. If the insulating layer 304, the conductive layer 310, and the protective layer 308 are laminated on the metal thin plate 302, each second terminal 37 is positioned between the hole 302b and the step 312.

As shown in FIG. 16, the long tail suspension 32d includes the metal thin plate 302 such as a stainless steel plate, the insulating layer 304, the conductive layer 310, and the protective layer 308. The insulating layer 304, the conductive layer 310, and the protective layer 308 are stacked in this order. These layers extend toward a direction opposite to the left-handed side surface 326 of the metal thin plate 302. The hole 302b is formed between the end of the metal thin plate 302 opposite to the floating head slider 23 and the step 312. In the insulating layer 304, the hole 302b is formed in such a position as to overlap the hole 302b of the metal thin plate 302 when the insulating layer 304 is laminated onto the metal thin plate 302. If the insulating layer 304, the conductive layer 310, and the protective layer 308 are laminated on the metal thin plate 302, each second terminal 37 is positioned between the end portion of the metal thin plate 302 opposite to the tail portion 72 of the terminal portion 70 and the hole 302b.

### Main FPC II:

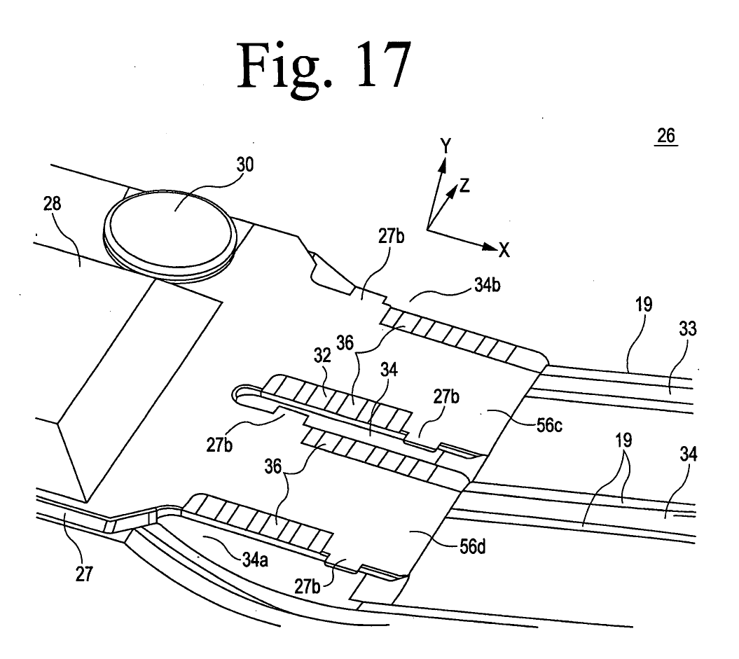

FIG. 17 shows the main FPC 26 of FIG. 12. As shown in FIG. 17, the main FPC 26 includes the first flat portion 56a and the second flat portion 56b. For example, the four first terminals 36 are formed at both end portions of the first fiat portion 56a and the second flat portion 56b. At least two of the long tail suspensions 32 are inserted to the groove 34 defined by the first flat portion 56a and the second flat portion 56b. The groove 34 is for accommodating a part the circuit board. The groove 34 includes an opening, a slit or a gap. And the main FPC 26 has an opening 34a and an opening 34b. For that purpose, the groove 34 has a width enough to receive at least two long tail suspensions 32. Further, the widths of the first flat portion 56a and the second flat portion 56b are determined in accordance with the width of each carriage arm 19.

The main FPC 26 includes, for example, four projections 27b engageable with the positioning hole 302b. The projection is an engaging portion or an engaged portion. For example, two of the four projections 27b are positioned between each first terminal 36 and the preamplifier IC 28. The remaining two projections 27b are positioned on an opposite side to the preamplifier IC 28 across the first terminal 36. The projection 27b protrudes toward the main FPC 26 from the long tail suspension 32 upon bonding the long tail suspension 32 to the main FPC 26. If the projection 27b is inserted to the hole 302b of the long tail suspension 32, the long tail suspension 32 is pulled toward the tail portion 72 to engage the projection 27b with the hole 302b. The projection 27b applies a force to the side of the hole 302b in contact with the projection 27b in a direction opposite to the tail portion 72. In this way, the long tail suspension 32 is pulled toward the tail portion 72 to thereby adjust positions of the first terminals 36 and the second terminals 37.

When the hole 302b is engaged with the projection 27b, a surface portion including the first terminals 36 and a surface portion including the second terminals 37 come into contact with each other in substantially vertical direction. The first terminal 36 is wider than the second terminal 37. As a result, the first terminal 36 and the second terminal 37 can easily contact each other. The first terminals are aligned with the second terminals, respectively. The first terminals 36 are arranged at smaller intervals than the second terminals 37. In addition, positions of the projection 27b and the hole 302b are determined so as to align the centers of each first terminal 36 ad each second terminal 37 with each other.

### Detailed Engagement Operation II:

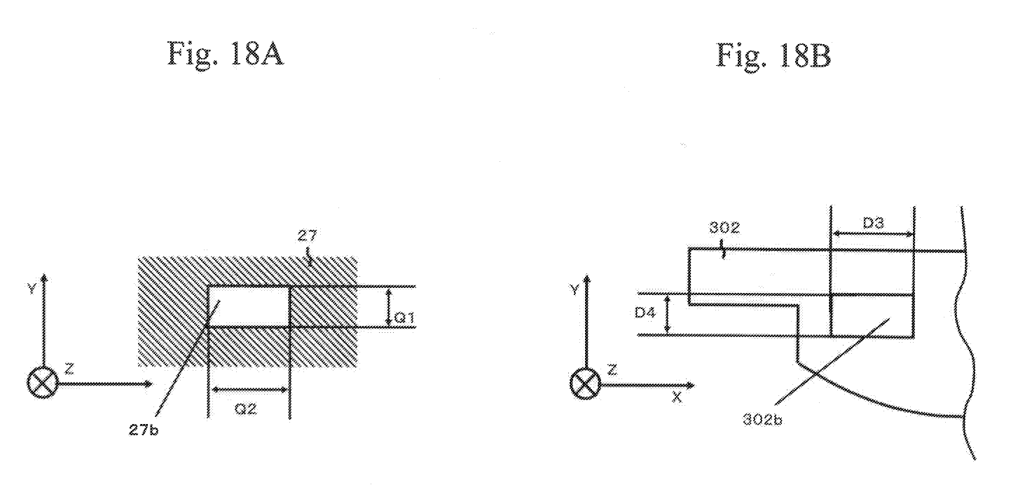

FIGS. 18A and 18B show a relationship between the positioning projection 27b and the hole 302b. As shown in FIG. 18A; a length Q2 of the positioning projection 27b in an X direction, that is, a direction parallel to each carriage arm 19 is shorter than a length D3 of the hole 302b in the X direction in FIG. 18B. Further, a length Q1 of the positioning projection 27b in a Y direction, that is, a direction vertical to the main FPC 26 is shorter than a length D4 of the hole 302b in the Y direction. As a result, the positioning projection 27b can be easily inserted to the hole 302b.

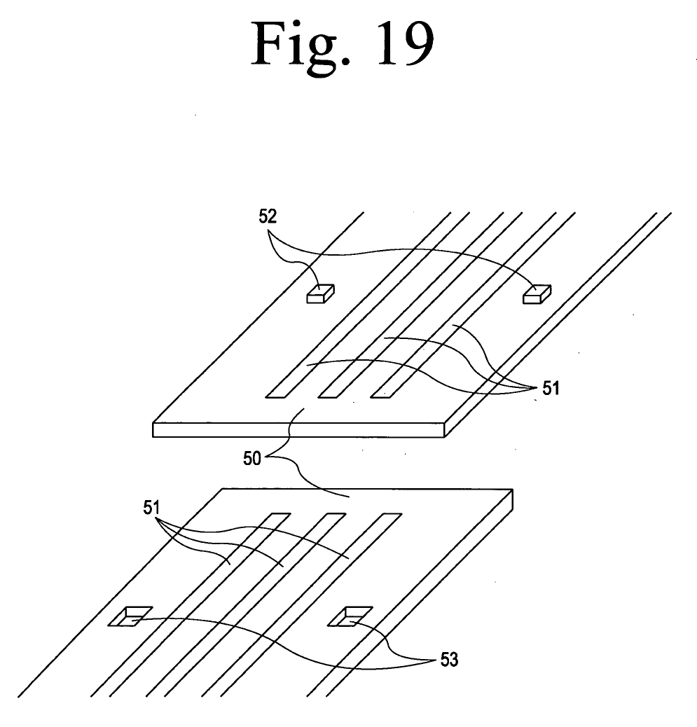

In this embodiment, as shown in FIG. 19, for example, a positioning protraction 52 formed on an FPC board 50 may be engaged to a positioning recess 53 formed in the FPC board 50 to thereby bring a wiring pattern 51 into contact therewith in a horizontal direction.

According to the embodiment, the long tail suspension and the flexible printed circuit board are bonded by engaging the holes and projections thereof. Thus, wiring patterns can be connected efficiently with high accuracy.

What is claimed is;

1. A magnetic head actuator assembly comprising:
a magnetic head assembly;
a suspension for supporting said magnetic head assembly at one end thereof;
a circuit board fixed to said suspension at one end thereof for providing a circuit connection to said magnetic head assembly, the circuit board having a plurality of terminals and an engaging portion at the other end thereof; and
a carriage for supporting said suspension at the other end of said suspension, the carriage having a connecting circuit board having a groove for receiving a part the circuit board where said plurality of terminals are formed, a plurality of connecting terminals, and an engaged portion, wherein said engaging portion of said circuit board is engaged to said engaged portion of the connecting circuit, board so as to align the terminals with the connecting terminals, respectively.

2. The magnetic head actuator assembly of claim 1, wherein said engaging portion of said circuit board is in the form of a slit and said engaged portion of said connecting circuit board is in the form of a tab inserted into said slit.

3. The magnetic head actuator assembly of claim 1, wherein said engaging portion of said circuit board is in the form of a tab and said engaged portion of said connecting circuit board is in the form of a slit for receiving said tab.

4. The magnetic head actuator assembly of claim 1, wherein said magnetic head assembly comprises a magnetic head and a slider mounting the magnetic head.

5. The magnetic head actuator assembly of claim 1, wherein the groove receives sheets of the circuit boards, respectively.

6. A memory device comprising:
a magnetic head assembly comprising a magnetic head and a slider mounting the magnetic head, the magnetic head being for writing data into or reading data from a recording medium;
a suspension for supporting said magnetic head assembly at one end thereof;
a circuit board fixed to said suspension at one end thereof for providing a circuit connection to said magnetic head assembly, the circuit board having a plurality of terminals and an engaging portion at the other end thereof; and
a carriage for supporting said suspension at the other end of said suspension, the carriage having a connecting circuit board including a plurality of connecting terminals, and an engaged portion, wherein said engaging portion of said circuit board is engaged to said engaged portion of the connecting circuit board so as to align the terminals with the connecting terminals, respectively,

7. The memory device of claim 6, wherein the connecting circuit board further has a groove for receiving a part the circuit board where said plurality of terminals are formed.

8. The memory device of claim 6, wherein said engaging portion of said circuit board is in the form of a slit and said engaged portion of said connecting circuit board is in the form of a tab inserted into said slit.

9. The memory device of claim 6, wherein said engaging portion of said circuit board is in the form of a tab and said engaged portion of said connecting circuit board is in the form of a slit for receiving said tab.

10. A long tail suspension for supporting a head slider at one end thereof and being able to be connected to a flexible printed circuit board at the other end thereof, the long tail suspension comprising:
a tail portion;
a plurality of terminals disposed at the end of the tail portion; and
an engaging portion disposed near the terminals and the engaging portion of the long tail suspension capable to be engaged to an engaged portion of the flexible printed circuit board so as to align the terminals with connecting terminals of the flexible printed circuit board, respectively.

11. The long tail suspension of claim 10, wherein the engaging portion of the long tail suspension is in the form of a slit and the engaged portion of the flexible printed circuit board is in the form of a tab inserted into the slit.

12. The long tail suspension of claim 10, wherein the engaging portion of the long tail suspension is in the form of a tab and the engaged portion of the flexible printed circuit board is in the form of a slit for receiving the tab.
